(19) United States
(12) Patent Application Publication
(10) Pub. No.: US 2013/0069898 A1
(43) Pub. Date: Mar. 21, 2013

(54) PAD FOR TOUCH PANEL AND TOUCH PANEL USING THE SAME

(71) Applicants: Jun-Young Park, Seoul (KR); Joo-Hyun Jeong, Ansan (KR); Dae-Young Jeong, Ansan (KR); Sang-Mo Bae, Ansan (KR)

(72) Inventors: Jun-Young Park, Seoul (KR); Joo-Hyun Jeong, Ansan (KR); Dae-Young Jeong, Ansan (KR); Sang-Mo Bae, Ansan (KR)

(73) Assignee: TMAY CO., LTD., Ansan, Gyeonggi-Do (unknown)

(21) Appl. No.: 13/636,633

(22) PCT Filed: Feb. 16, 2011
(86) PCT No.: PCT/KR2011/000999

§ 371 Date: Oct. 5, 2012

(30) Foreign Application Priority Data
Mar. 25, 2010 (KR) 10-2010-0026546

(51) Int. Cl. G06F 3/041

(52) U.S. Cl. 345/173; 178/18.03

(57) ABSTRACT

There are provided a pad for touch panel and a touch panel using the same, and more particularly, a pad for touch panel comprising an insulating layer with a conductive pattern wherein the insulating layer has a touch pattern and a lead wire formed on the top surface thereof, and one terminal of the lead wire is extended to an edge of the insulating layer to form a connection electrode, characterized in that the pad for touch panel at least comprises i) an insulating layer with conductive pattern comprising the insulating layer, a transparent conductive coating layer pattern which is partially laminated on the top of the insulating layer and has the touch pattern, the lead wire and the connection electrode pattern thereon, and a metal coating layer which is partially laminated on the top of the transparent conductive coating layer and has the lead wire and the connection electrode pattern thereon; ii) an adhesive layer which is laminated on the top of the insulating layer with conductive pattern; and iii) a coupling layer which is coupled to the top of the adhesive layer; the connection electrode region has an open portion where the top surface of the metal coating layer is open externally; and the open portion further comprises a corrosion-resistant metal layer which is coated to the open portion to disconnect the open portion from the outside, and a touch panel using the same. Through this, the present invention can enhance the durability of touch panels by coating with an excellent corrosion-resistant metal an open portion of a connection electrode region of the pad for touch panel which is formed to electrically connect the pad for touch panel with external circuit boards such as an FPCB, thereby to solve corrosion problems in the open portion of the connection electrode region.

### CROSS-REFERENCES TO RELATED APPLICATIONS

This application is a U.S. national phase application, pursuant to 35 U.S.C. §371, of PCT/KR2011/000999, filed Feb. 16, 2011, designating the United States, which claims priority to Korean Application No. 10-2010-0026546, filed Mar. 25, 2010. The entire contents of the aforementioned patent applications are incorporated herein by this reference.

### FIELD OF THE INVENTION

The present invention relates to a pad for touch panel and a touch panel using the same, and there are provided a pad for touch panel and a touch panel using the same capable of enhancing the durability of touch panel by coating with an excellent corrosion-resistant metal an open portion of a connection electrode region of the pad for touch panel which is formed to electrically connect the pad for touch panel with external circuit boards such as an FPCB, thereby to solve corrosion problems in the open portion of the connection electrode region.

### BACKGROUND OF THE INVENTION

In the manufacture of touch panels in prior arts, as pads which are in a state of raw materials before process, laminate pads obtained by coating ITO onto insulating layers such as a glass or an insulating resin have been used, and an ITO (Indium Tin Oxide) pattern layer obtained by etching the ITO layer and for electrical connection to the outside, silver pastes have been generally used. In the manufacture of silver paste-based conducting wires, however, as there is a limit of applying a thin silver paste, the conducting wires become thick. Hence, a large step height occurs in top and bottom directions and the widths of conducting wires become wide in plane directions and thus, efforts have been made to address these problems.

Therefore, in recent years, as the laminate pads, there have been applied laminate pads formed by coating an insulating layer (10) with ITO (20) and forming a copper layer (30) on the top surface thereof, and one example of how a pad for touch panel with the pattern using this formed thereon is manufactured is shown in FIG. 1. First, copper (30) and ITO (20) are simultaneously removed from all the areas except the parts (union of two sets) that falls into any of lead wires regions and pattern regions of touch part by attaching a first mask to the areas where copper (30) and ITO (20) are to be removed at the same time and the first mask is then removed. Next, as the removal of a copper layer (30) that corresponds to a window part of the pad enables a display which is later to be coupled with the touch panel, to be seen, even when coupled with the underneath of the touch panel, a second mask is attached to the remaining areas of the window region except the copper (30) layer which has to be removed and the thus exposed copper layer (30) are etched and the second mask is then removed to prepare a pad which will be laminated onto a touch panel.

In electrostatic capacitance type, the pad prepared by the above methods is prepared by FIG. 2 (a) and then it is laminated with a partially-blanked OCA (Optical Clear Adhesive) layer on the top or bottom thereof, respectively, as shown in FIG. 2 (b). Next, an FPCB (Flexible Printed Circuit Board) (40) connection part is prepared by blanking with regard to its one side as shown in FIG. 2 (c) and the thus prepared two layers are laminated to form a pad for touch panel as shown in FIG. 3.

In the pattern formation through this procedure, the coupling between the pad with the pattern formed thereon and an FPCB (Flexible Printed Circuit Board) that is connected thereto is carried out as shown in FIG. 4 which illustrates its partial section, wherein a pad on which the pattern is formed is prepared in FIG. 4 (a), an FPCB (40) is then attached thereto in FIG. 4 (b) and then, they are coupled to each other by compressing a heated tip (50) in the top of a contact surface. However, in this process, a copper layer (30) is exposed, and the thus exposed copper layer (30) causes degradation in its durability because corrosion occurs in the copper layer (30) as shown in reliability tests such as salt spray test in FIG. 5.

Therefore, there is a need for the development of a pad for touch panel that can solve such problems.

### SUMMARY OF THE INVENTION

Accordingly, it is an object of the present invention to provide a pad for touch panel and a touch panel using the same capable of enhancing its durability by coating with an excellent corrosion-resistant metal an open portion of a connection electrode region of the pad for touch panel which is formed to electrically connect the pad for touch panel with external circuit boards such as an FPCB, thereby to solve corrosion problems in the open portion of the connection electrode region.

In order to achieve the object, the present invention provides a pad for touch panel comprising an insulating layer with a conductive pattern wherein the insulating layer has a touch pattern and a lead wire formed on the top surface thereof, and one terminal of the lead wire is extended to an edge of the insulating layer to form a connection electrode, characterized in that

the pad for touch panel at least comprises i) an insulating layer with conductive pattern comprising the insulating layer, a transparent conductive coating layer pattern which is partially laminated on the top of the insulating layer and has the touch pattern, the lead wire and the connection electrode pattern thereon, and a metal coating layer which is partially laminated on the top of the transparent conductive coating layer and has the lead wire and the connection electrode pattern thereon; ii) an adhesive layer which is laminated on the top of the insulating layer with conductive pattern; and iii) a coupling layer which is coupled to the top of the adhesive layer; the connection electrode region has an open portion where the top surface of the metal coating layer is open externally; and

the open portion further comprises a corrosion-resistant metal layer which is coated to the open portion to disconnect the open portion from the outside.

Also, the invention provides a touch panel comprising as a laminating layer a pad for touch panel that has a touch pattern and a lead wire formed on the top surface thereof,

wherein the pad for touch panel is the pad for touch panel according to the present invention.

The pad for touch panel and the touch panel using the same in accordance with the present invention enhances the durability of touch panels by coating with an excellent corrosion-resistant metal an open portion of a connection electrode region of the pad for touch panel which is formed to electrically connect the pad for touch panel with external circuit boards such as an FPCB, thereby to solve corrosion problems in the open portion of the connection electrode region.

### BRIEF DESCRIPTION OF THE DRAWINGS

FIG. 1 is schematic sectional structures showing one example of how a pad for touch panel in prior arts is prepared.

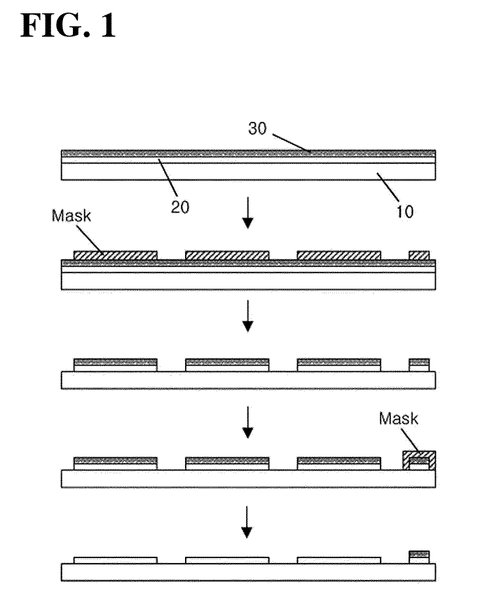

FIG. 2 is schematic plane structures in sequence showing one example of how a pad for touch panel in prior arts is laminated to prepare an electrostatic capacitance touch panel.

FIG. 3 shows a specific example of an electrostatic capacitance touch panel pad that has been laminated according to the example shown in FIG. 2.

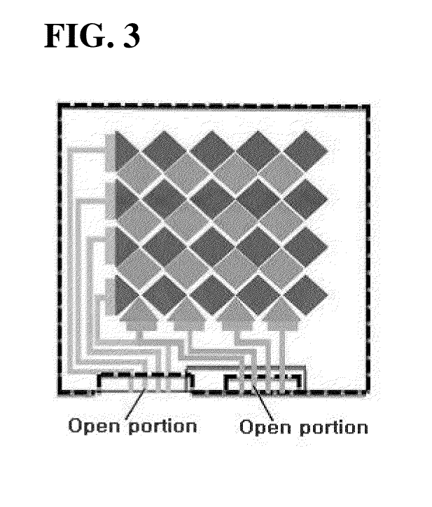

FIG. 4 is schematic sectional structures in sequence showing one example of how a pad for touch panel in prior arts is coupled with a printing circuit board.

FIG. 5 are photographs showing the corrosion of metal layers after reliability test, in the coupled body prepared by coupling the pad for touch panel in prior arts with the printing circuit board.

FIG. 6 is a schematic plane structure showing one embodiment of the pad for touch panel of the present invention that is applicable to the example shown in FIG. 2.

FIG. 7 is sectional structures showing one example of a touch panel formed by laminating the pad for touch panel of the present invention.

### DETAILED DESCRIPTION OF THE INVENTION

Hereafter, the invention will be described in detail with reference to the drawings.

The invention relates to a pad for touch panel, more particularly, to a pad for touch panel comprising an insulating layer with a conductive pattern wherein the insulating layer has a touch pattern and a lead wire formed on the top surface thereof, and one terminal of the lead wire is extended to an edge of the insulating layer to form a connection electrode, wherein the pad for touch panel at least comprises i) an insulating layer with conductive pattern comprising the insulating layer, a transparent conductive coating layer pattern which is partially laminated on the top of the insulating layer and has the touch pattern, the lead wire and the connection electrode pattern thereon, and a metal coating layer which is partially laminated on the top of the transparent conductive coating layer and has the lead wire and the connection electrode pattern thereon; ii) an adhesive layer which is laminated on the top of the insulating layer with conductive pattern; and iii) a coupling layer which is coupled to the top of the adhesive layer; the connection electrode region has an open portion where the top surface of the metal coating layer is open externally; and the open portion further comprises a corrosion-resistant metal layer which is coated to the open portion to disconnect the open portion from the outside.

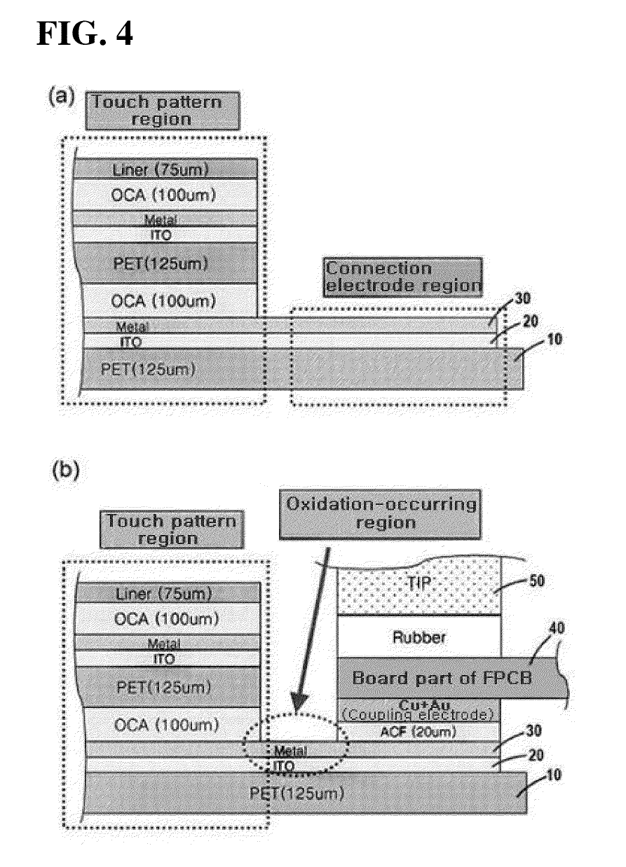

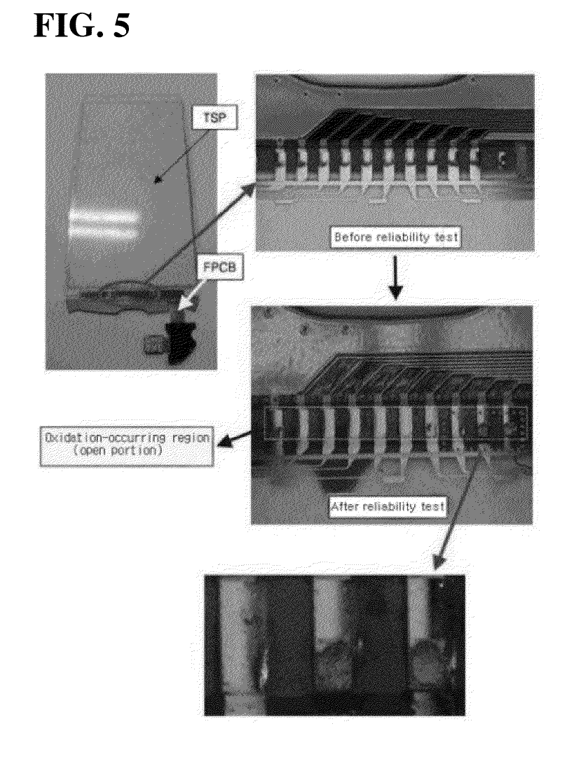

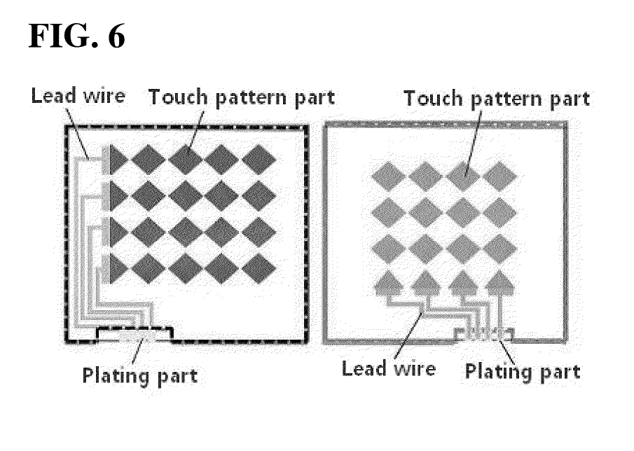

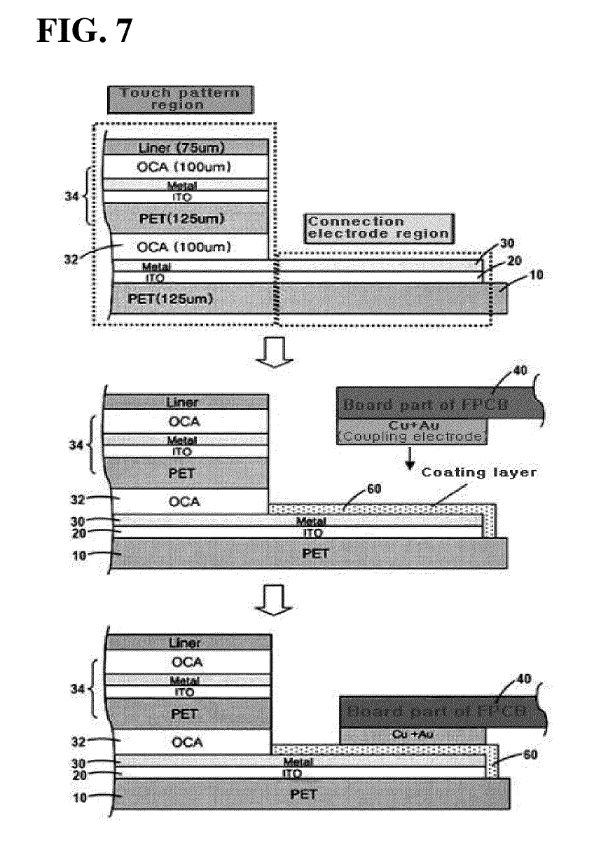

A specific example of the invention is as shown in FIGS. 6 to 7. In order to solve the durability problems associated with the surface exposure of the metal coating layer (30) as shown in FIGS. 4 to 5, the metal coating layer (30) that becomes exposed after the coupling procedure between the pads for touch panel and the printing circuit boards, preferably FPCB (40) is covered with a corrosion-resistant metal layer with excellent corrosion resistance.

The pad is a pad for touch panel in the form of comprising an insulating layer with a conductive pattern that has a touch pattern and a lead wire formed on the top surface thereof and a connection electrode formed by the extension of one terminal of the lead wire to an edge, and a specific example thereof is as shown in FIG. 6. FIG. 6 shows a state where an OCA has been attached.

More particularly, the pad for touch panel has a laminating structure having i) an insulating layer (10, 20, 30) with conductive pattern comprising the insulating layer (10), a transparent conductive coating layer (20) which is partially laminated on the top of the insulating layer (10) and has the touch pattern, the lead wire and the connection electrode pattern thereon, and a metal coating layer (30) which is partially laminated on the top of the transparent conductive coating layer (20) and has the lead wire and the connection electrode pattern thereon; ii) an adhesive layer (32) which is laminated on the top of the insulating layer (10, 20, 30) with conductive pattern; and iii) a coupling layer (34) which is coupled with the top of the adhesive layer (32), and a specific example thereof is as shown in FIGS. 6 and 7.

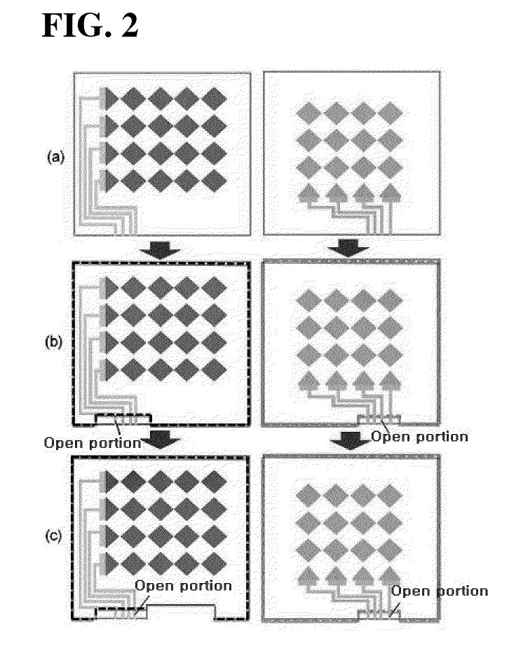

The connection electrode region has an open portion where the top surface of the metal coating layer (30) is open externally, as shown in FIG. 2, and the open portion further comprises a corrosion-resistant metal layer (60) which is coated onto the open portion to disconnect the open portion from the outside, thereby to prevent its corrosion. Each connection electrode has a corrosion-resistant metal layer in order to be electrically separated, and corrosion resistance can be enhanced by the coating, preferably, plating of the corrosion-resistant metal layer (60), with regard to not only the top surface of each connection electrode but also the side surface thereof.

Preferably, the metal coating layer (30) may comprise copper which is excellent in terms of conductivity and cost but has poor corrosion resistance, and the copper is generally deposited via a sputtering process as a laminating layer. The corrosion-resistant metal layer (60) which is coated to prevent the corrosion of the copper may comprise gold, silver, nickel, tin, molybdenum or an alloy thereof which are excellent in terms of conductivity and corrosion resistance, for the coating of the corrosion-resistant metal layer (60), there may be applied deposition methods such as sputtering or plating, and preferably, for the convenience of application, plating, especially non-electrolytic plating or substitution plating may be applied and further, so as to specify the areas to be plated, a mask (cover layer) may be applied so that the plating can be performed in only a certain area.

Further, the invention provides a touch panel comprising a pad for touch panel where an open portion of a metal coating layer (30) that corresponds to the connection electrode region of the invention is coated with a corrosion-resistant metal layer (60), and in the touch panel comprising as a laminating layer a pad for touch panel with a touch pattern and a lead wire formed on the top surface thereof, the pad for touch panel is constituted by the pad for touch panel according to the invention. This means that in the pads that are applied to prepare conventional touch panels, the open portion of the metal coating layer (30) that corresponds to the connection electrode region is coated with corrosion-resistant metals (60), and through this, in case of being connected with circuit boards such as an FPCB (40), it has a structure where the corrosion-resistant metal layer (60) is inserted between the coupling electrodes of the circuit boards and the connection electrodes of the pad and the remaining open portion prevents corrosion by isolating the metal coating layer (30) from the outside through the corrosion-resistant metal layer (60).

It is to be understood that the invention as described in the above is not limited by the aforementioned examples and accompanying drawings, and various modifications and alterations made by those skilled in the pertinent art within the spirit and scope of the invention defined by the following claims are still within the scope of the invention.

The pad for touch panel and the touch panel using the same in accordance with the present invention enhances the durability of touch panels by coating with an excellent corrosion-resistant metal an open portion of a connection electrode region of the pad for touch panel which is formed to electrically connect the pad for touch panel with external circuit boards such as an FPCB, thereby to solve corrosion problems in the open portion of the connection electrode region.

1. A pad for touch panel comprising an insulating layer with a conductive pattern wherein the insulating layer has a touch pattern and a lead wire formed on the top surface thereof, and one terminal of the lead wire is extended to an edge of the insulating layer to form a connection electrode, characterized in that
the pad for touch panel at least comprises i) an insulating layer with conductive pattern comprising the insulating layer, a transparent conductive coating layer pattern which is partially laminated on the top of the insulating layer and has the touch pattern, the lead wire and the connection electrode pattern thereon, and a metal coating layer which is partially laminated on the top of the transparent conductive coating layer and has the lead wire and the connection electrode pattern thereon; ii) an adhesive layer which is laminated on the top of the insulating layer with conductive pattern; and iii) a coupling layer which is coupled to the top of the adhesive layer; the connection electrode region has an open portion where the top surface of the metal coating layer is open externally; and
the open portion further comprises a corrosion-resistant metal layer which is coated to the open portion to disconnect the open portion from the outside.

2. The pad for touch panel according to claim 1 wherein the metal coating layer is copper, and the corrosion-resistant metal layer is a plated layer of gold, silver, nickel, tin, molybdenum or an alloy thereof.

3. A touch panel comprising as a laminating layer a pad for touch panel that has a touch pattern and a lead wire formed on the top surface thereof, wherein the pad for touch panel is the pad for touch panel according to claim 1 or 2.
